(19) United States
(12) Patent Application Publication
(10) Pub. No.: US 2007/0147032 A1
(43) Pub. Date: Jun. 28, 2007

(54) VISIBLE LIGHT COMMUNICATION ORIENTED ILLUMINATION DEVICE

(75) Inventors: Chisato Furukawa, Minato-ku, Tokyo (JP); Takafumi Nakamura, Minato-ku, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/610,743

(22) Filed: Dec. 14, 2006

(30) Foreign Application Priority Data
Dec. 15, 2005 (JP) 2005-362282

(51) Int. Cl. F21V 9/00

(52) U.S. Cl. 362/230; 362/800

(57) ABSTRACT

A visible light communication oriented illumination device includes: a transmitting section including a light emitting element which emits an excitation light, a first wavelength-converting material, and a second wavelength-converting material; and a receiving section including a receiver and a demodulator. The first wavelength-converting material absorbs the excitation light and emits a first light. The second wavelength-converting material absorbs the excitation light and emits a second light which is different in wavelength and has a shorter 1/10 persistence time than the first light. The transmission section is configured to emit an illuminating light including the first and second lights. The receiver receives the second light and transforms the second light into an electrical signal, and the demodulator receives the electrical signal outputted from the receiving section and outputs a signal corresponding to an information transmitted from the transmitting section.

### CROSS-REFERENCE TO RELATED APPLICATIONS

This application is based upon and claims the benefit of priority from the prior Japanese Patent Application No.2005-362282, filed on Dec. 15, 2005; the entire contents of which are incorporated herein by reference.

### BACKGROUND

In the field of semiconductor light emitting elements, recent years have seen the development of LEDs and LDs capable of emitting blue to near-ultraviolet light by using gallium nitride-based materials. These semiconductor light emitting elements are used as light sources to develop light emitting devices applicable to illumination and display. Furthermore, visible light communication oriented illumination devices are being developed using the above light emitting device as a space optical transmission unit.

There is disclosed a white LED capable of rapid modulation aiming to transmit a large amount of information. For example, JP 2001-111114A discloses a white LED comprising an ultraviolet LED light source and a plurality of red-, blue-, and green-emitting particles made of non-phosphor, group II-VI or III-V semiconductors.

This light emitting device (white LED) is not based on phosphors which contain luminescent centers localized in the solid, and hence has a possibility of turning on and off white light at a high speed. However, use of the above disclosed light emitting particles may have a problem of insufficient brightness of the light emitting device.

JP 2004-363756A discloses an illumination device where a part of a direct light from a light source having a wavelength of 390 nm is used as a modulation light for optical transmission and the remaining part of the direct light from the light source is converted by phosphors into an illuminating light. However, because only a part of the light from the light source is used as an illuminating light, the above disclosed illumination device has complicated illumination optics, and the amount of illuminating light decreases.

### SUMMARY

According to an aspect of the invention, there is provided a visible light communication oriented illumination device including: a transmitting section including: a light emitting element which emits an excitation light; a first wavelength-converting material which absorbs the excitation light and emits a first light; and a second wavelength-converting material which absorbs the excitation light and emits a second light which is different in wavelength and has a shorter 1/10 persistence time than the first light, the transmission section being configured to emit an illuminating light including the first and second lights; and a receiving section including: a receiver which receives the second light and transforms the second light into an electrical signal; and a demodulator which receives the electrical signal outputted from the receiving section and outputs a signal corresponding to an information transmitted from the transmitting section.

According to other aspect of the invention, there is provided a visible light communication oriented illumination device including: a light emission controller which generates a modulating electrical signal for transmitting information; a light emitting device including: a light emitting element which emits an intensity-modulated excitation light in response to the modulating electrical signal; a first wavelength-converting material which absorbs the excitation light and emits a first visible light; and a second wavelength-converting material which absorbs the excitation light and emits a second visible light which is different in wavelength and has a shorter 1/10 persistence time than the first visible light; and a receiving section which receives the second visible light.

### BRIEF DESCRIPTION OF THE DRAWINGS

FIG. 1 is a block diagram which schematically shows the configuration of a visible light communication oriented illumination device according to a first embodiment.

FIG. 2 is a cross-sectional view which schematically shows the structure of a light emitting device according to the first embodiment.

FIG. 3 is a schematic view which conceptually shows the configuration of the light emitting device according to the first embodiment.

FIG. 4 schematically shows an emission spectrum primarily in the visible light region of the light emitting device according to the first embodiment.

FIG. 5 is a timing chart which schematically shows the waveform of an input signal and an output signal of the visible light communication oriented illumination device according to the first embodiment, where the horizontal axis represents time, FIG. 5A shows a signal waveform inputted to the light emitting device, FIG. 5B shows the emission intensity of the excitation light in the light emitting device, and FIG. 5C shows the emission intensity of the converted light emitted from the light emitting device.

FIG. 6 is a cross-sectional view which schematically shows the structure of a light emitting device according to a second embodiment.

FIG. 7 schematically shows an emission spectrum primarily in the visible light region of the light emitting device according to the second embodiment.

FIG. 8 is a cross-sectional view which schematically shows the structure of a light emitting device according to a third embodiment.

FIG. 9 is a cross-sectional view which schematically shows the structure of a light emitting device according to a fourth embodiment.

FIG. 10 is a cross-sectional view which schematically shows the structure of a light emitting device according to a fifth embodiment.

### DETAILED DESCRIPTION

Embodiments of the invention will now be described with reference to the drawings, where like components are marked with like reference numerals. In the following, the same components are marked with the same reference numerals and explanations may be appropriately omitted, whereas differing components may be described.

### First Embodiment

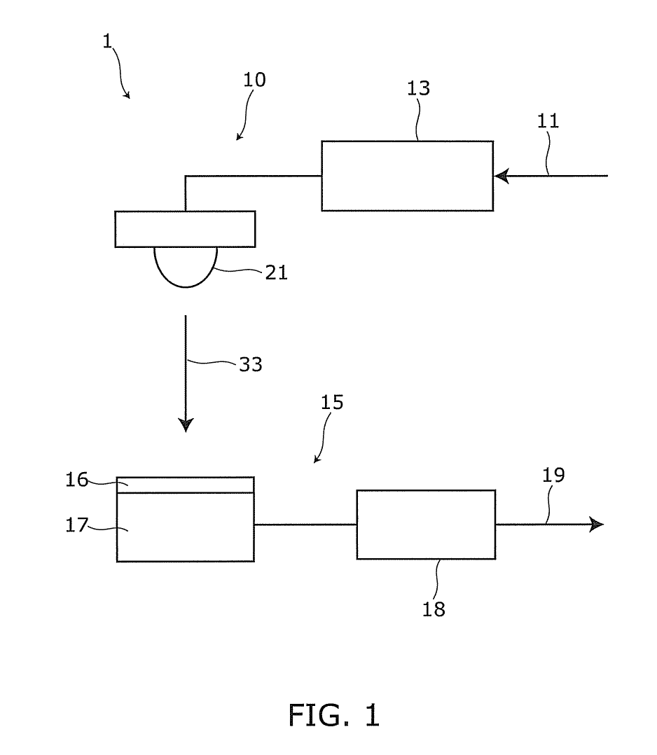

A light emitting device and a visible light communication oriented illumination device according to the first embodiment of the invention are described with reference to FIGS. 1 to 5. The visible light communication oriented illumination device according to the embodiment can be used as a ceiling light, for example, as a white light source, and also has a function of a light communication.

As shown in FIG. 1, the visible light communication oriented illumination device 1 includes a light emission controller 13, which generates a modulating electrical signal for transmitting information, a light emitting device 21, which emits an excitation light based on the modulating electrical signal and absorbs the excitation light to emit a plurality of converted lights 33 into space, the converted lights being combined into white light, and a light receiver 17 capable of receiving one of the white converted lights 33 in a wavelength selective manner, the one converted light 33 having the shortest persistence characteristic. The visible light communication oriented illumination device 1 can be divided into a transmitting section 10 for emitting the converted lights 33 including the light emission controller 13 and the light emitting device 21 and a receiving section 15 including the light receiver 17 for selectively receiving the converted light 33 and a demodulator 18.

The transmitting section 10 and the receiving section 15 may be formed into a single package, alternatively, they may be separate and placed at distant positions. For example, the transmitting section 10 may be placed on a ceiling of a room and is used as a illumination source. On the other hand, the receiving section 15 may be attached on a floor, a wall or in an equipment such as personal computer placed in the room.

The light emission controller 13 receives an input signal 11 including information to be transmitted and outputs a modulating electrical signal to the light emitting device 21, where the modulating electrical signal depends on the transmission rate and is made of 0s and 1s, for example. The light receiver 17 receives the converted light 33 and transforms it into an electrical signal. The light receiver 17 has a filter 16 for receiving one of the converted lights 33, where the filter 16 is tuned to the wavelength of the converted light 33 having the shortest persistence characteristic. As described later, the converted light 33 exhibits a white color by a combination of two spectra having intensity peaks at blue and yellow, respectively. The filter 16 is configured to pass yellow light, which is more suitable to high-speed transmission. For example, an optical film formed on the surface of the light receiving element allows only the yellow light to be selectively received. The demodulator 18 applies operations such as amplification, identification, and shaping to the electrical signal from the light receiver 17 and outputs a signal corresponding to the transmitted information.

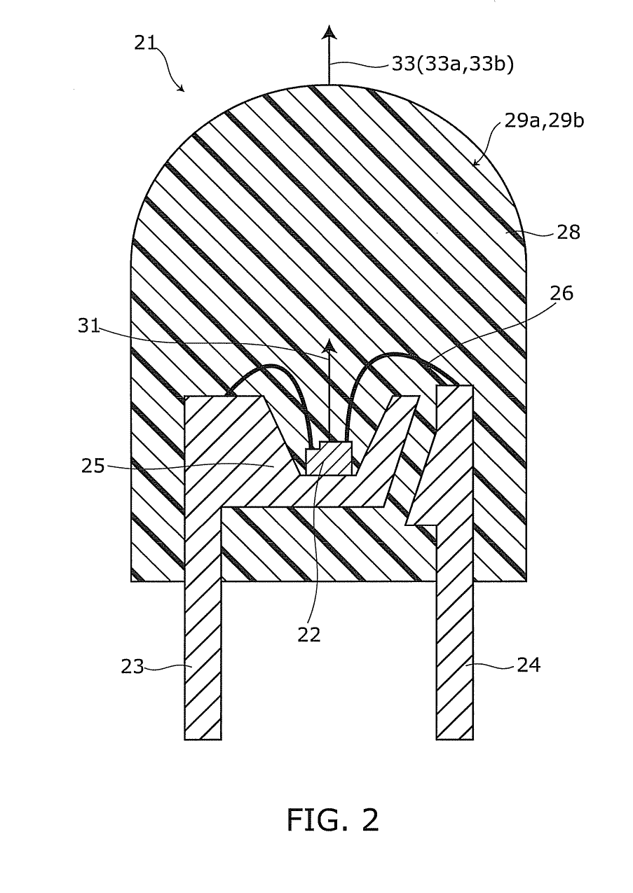

As shown in FIG. 2, the light emitting device 21 includes an LED chip 22 serving as a light emitting element which emits an excitation light 31, a phosphor 29a serving as a first wavelength-converting material which absorbs the excitation light 31 and emits a blue converted light 33a as a first visible light, and a phosphor 29b serving as a second wavelength-converting material which absorbs the excitation light 31 and emits a yellow converted light 33b as a second visible light, which has a longer wavelength and shorter persistence time than the first visible light.

In the light emitting device 21, a cup portion 25 with an LED chip 22 being fixed to the recess bottom surface thereof, a lead 23 connected to the cup portion 25 and serving as an external terminal, a lead 24 serving as another external terminal paired with the lead 23, wires 26 which electrically connect the LED chip 22 to the leads 23, 24, and a sealing resin 28 containing phosphors 29a, 29b and sealing the LED chip 22, the cup portion 25, one end of the leads 23, 24, and the wires 26 are provided. The light emitting device 21 is formed into a bullet shape.

The LED chip 22 is a gallium nitride-based semiconductor light emitting element formed on a sapphire, SiC, GaN, or other substrate and having an emission wavelength of 400 nm or less. For example, although not shown in detail, a double heterostructure having a light emitting layer made of nitride semiconductor is laminated on a sapphire substrate by MOCVD (Metal Organic Chemical Vapor Deposition) or the like. A p-side and an n-side electrode available for bonding are formed on the frontside. The LED chip 22 has an emission intensity peak at 360 to 380 nm, for example. The LED chip 22 blinks the light source to modulate the supplied power waveform with an information signal, thereby achieving a transmission performance corresponding to a transmission rate of 10 Mbps or more.

The phosphors 29a, 29b contain luminescent centers (activation centers) localized in the solid and are excited by a near-ultraviolet excitation light 31 having an intensity peak at 400 nm or less emitted from the LED chip 22. A blue converted light 33a and a yellow converted light 33b emitted from the phosphors 29a, 29b, respectively, which are in a relation of complementary colors to each other, are combined into a white converted light 33 available as an illuminating light. The converted lights 33a, 33b emitted by the phosphors 29a, 29b can be used for visible light communication, although the modulation rate is lower than that for the LED chip 22 because the converted lights 33a, 33b have some persistence.

The phosphor 29a is illustratively (Sr,Ca,Ba)₅(PO₄)₃Cl:Eu, which emits blue. The phosphor 29b is illustratively YAG(yttrium aluminum garnet):Ce or YAG:Ce,Tb, which emits yellow. The phosphors 29a, 29b have a 1/10 persistence time of 1 to 10 μsec and 0.1 to 0.2 μsec, respectively. YAG activated with Ce tends to have a shorter persistence time than phosphors with other activators, and hence is advantageous to the speedup of visible light communication. Here the 1/10 persistence time is defined as the time elapsed until the emission intensity of the persistence of an excited phosphor after terminating excitation decreases to 1/10 of the emission intensity immediately before terminating the excitation. The 1/10 persistence time is hereinafter simply referred to as the persistence time. Note that, while the phosphors 29a, 29b fluorescing blue and yellow light are combined in this embodiment, other combinations of two fluorescent colors can be used as long as they are in a relation of complementary colors to each other.

The paired leads 23, 24 and the cup portion 25 are formed from a lead frame. The cup portion 25 is provided at the tip of the lead 23. One end of the lead 24 is closely opposed to and spaced apart from the cup portion 25. The other ends of the leads 23, 24 extend outside the sealing resin 28 parallel to each other.

The cup portion 25 has a recess which opens toward the tip. The backside sapphire substrate of the LED chip 22 is fixed to the bottom face of the recess using silver paste as an adhesive. Advantageously, silver paste reflects near-ultraviolet light and is also heat dissipative. The inner wall side face of the recess is formed into a smooth surface, which reflects and emits the excitation light 31 of the LED chip 22 and the converted light 33 toward the tip. Note that the silver paste is not limitative, but other resin-based adhesives or eutectic alloy solders can be used for adhesion.

The p-side and n-side electrode of the LED chip 22 are placed on the surface opposed to the tip and are connected to the lead 24 and the cup portion 25 via gold wires 26, respectively. Note that the p-side and n-side electrode can be connected conversely.

The sealing resin 28 contains phosphors 29a, 29b which convert the excitation light 31 emitted from the LED chip 22. The phosphors 29a, 29b in the sealing resin 28 are dispersed so that nearly all the excitation light 31 is not emitted outside the LED chip 22. The sealing resin 28 is a silicone-based resin which is less prone to degradation by the excitation light.

To make the sealing with the silicone-based resin, for example, phosphors 29a, 29b are mixed and stirred into the silicone-based resin, which is formed into a bullet shape so as to cover the LED chip 22, the cup portion 25, one end of the leads 23, 24, and the wires 26, and then cured. The LED chip 22 is placed nearly on the optical axis of the convex lens at the tip of the bullet shape.

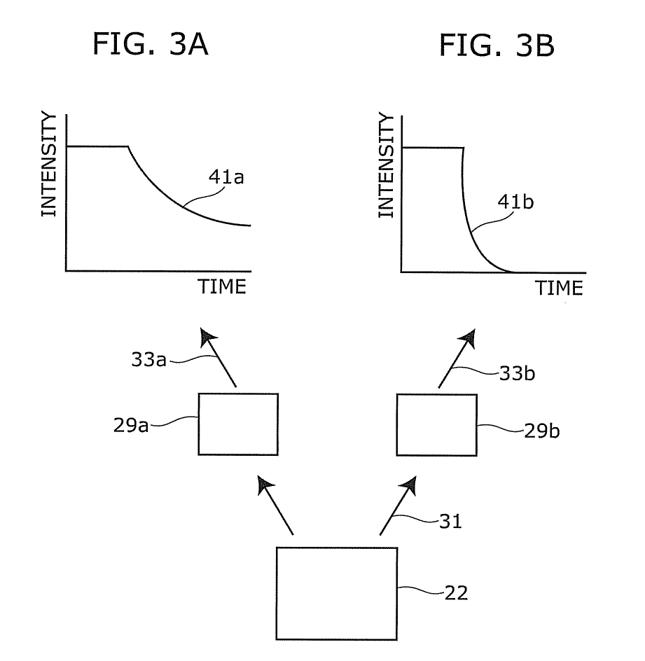

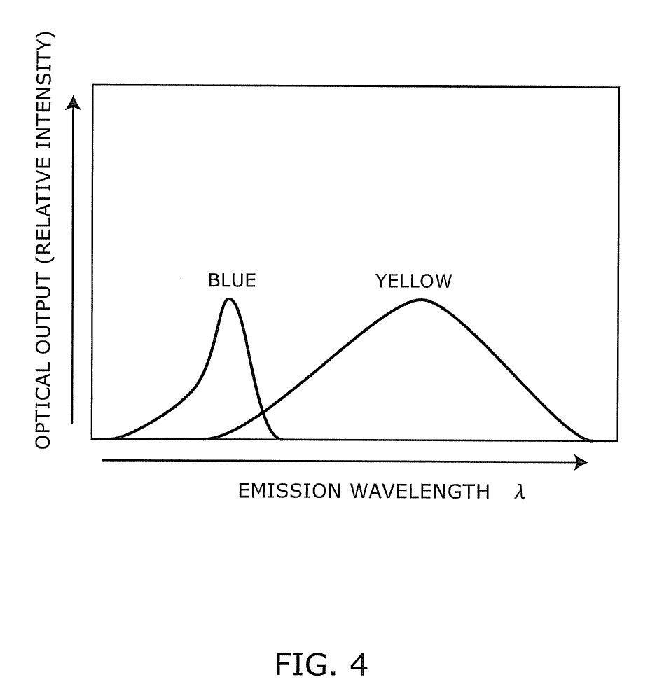

Some of the features of the above-described light emitting device 21 are summarized as follows. As shown in FIG. 3, the LED chip 22 emits a near-ultraviolet excitation light 31. The near-ultraviolet excitation light 31 is absorbed by phosphors 29a, 29b. As shown in FIGS. 3A and 4, the phosphor 29a emits a blue converted light 33a having an intensity peak at 450 to 460 nm. As shown in FIGS. 3B and 4, the phosphor 29b emits a yellow converted light 33b having an intensity peak at 540 to 560 nm. As a result of combination of the blue converted light 33a and the yellow converted light 33b, the light emitting device 21 emits a white converted light 33.

As shown in FIG. 3A, the persistence intensity 41a of the blue converted light 33a exhibits a relatively gradual decrease with a persistence time of 5 to 10 μsec. On the other hand, as shown in FIG. 3B, the persistence intensity 41b of the yellow converted light 33b decreases more rapidly than the persistence intensity 41a, with a persistence time of about 0.15 μsec.

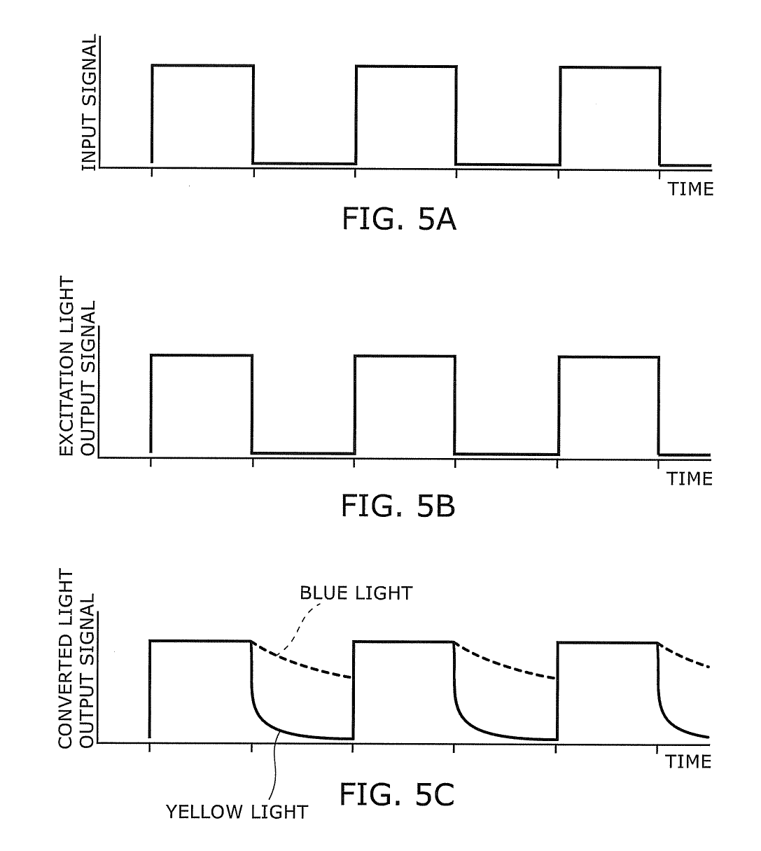

Next, the operation of the visible light communication oriented illumination device 1 is described. An input signal 11 is inputted to the light emission controller 13, and a modulating electrical signal is outputted to the light emitting device 21. For example, upon receiving the input signal shown in FIG. 5A, the LED chip 22 of the light emitting device 21 emits an intensity-modulated excitation light 31 having an emission intensity shown in FIG. 5B. The phosphors 29a, 29b excited upon absorbing the excitation light 31 emit converted lights 33a, 33b as shown in FIG. 5C, which appear as white light to the eye. Note that FIG. 5C shows a normalized emission intensity immediately before terminating excitation for the purpose of comparing the persistence characteristics, where the blue light and the yellow light do not necessarily have the same emission intensity. In addition to compensate for the difference of luminosity (visibility) to obtain a white converted light 33, it is possible to adjust the emission intensity of the blue light and the yellow light by varying the amount and/or distribution of the phosphors 29a, 29b to compensate for the difference of persistence characteristics during transmission and pulsed operation.

The transmission waveforms are compared. The horizontal axis is marked in 1 μsec increments. The output signal of the excitation light 31 shown in FIG. 5B tracks the input signal of FIG. 5A and exhibits a waveform of a nearly identical shape having a cycle of 2 μsec. As compared with the waveform of the excitation light 31 shown in FIG. 5B, the yellow converted light 33b in the converted light output signal of FIG. 5C exhibits a waveform with tracking capability because of its short persistence time. On the other hand, the blue converted light 33a having a long persistence time exhibits a waveform without tracking capability. That is, the yellow light can transmit the input signal having a cycle of 2 μsec, but the blue light cannot.

Next, the yellow converted light 33b is passed through the filter 16 transparent to yellow light and inputted to the light receiver 17. The light receiver 17 transforms the converted light 33b into an electrical signal and sends it to the demodulator 18. The demodulator 18 applies operations such as amplification, identification, and shaping to the electrical signal and outputs a signal corresponding to the input signal 11, thereby enabling the space optical transmission.

As described above, in the light emitting device 21, the near-ultraviolet light emitted from the LED chip 22 serves as an excitation light 31, and blue and yellow converted light 33a, 33b are emitted as an illuminating light from the phosphors 29a, 29b excited by the excitation light 31. The resulting white illumination is in the range of practical use. The phosphors 29a, 29b have a conversion efficiency nearly comparable to those of phosphors used in current fluorescent lamps. Furthermore, there is the potential of surpassing current fluorescent lamps through the enhancement of the performance and the light extraction efficiency of the LED chip 22.

The LED chip 22 is an LED emitting near-ultraviolet light, not a blue-emitting LED. As compared with the blue-emitting LED, the performance difference between the devices, variation of supply current, variation with ambient temperature, and variation with time are reduced. Furthermore, the direct light from the LED chip 22 is used for exciting the phosphors 29a, 29b, and does not constitute the combined white light. Thus the imbalance in the white light is prevented. Therefore the light emitting device 21 is suitable to providing a white illuminating light with high stability.

Moreover, the light emitting device 21 is based on phosphors with different persistent times. The converted light 33b has a shorter persistent time of about 0.15 μsec. A light receiver 17 for selectively receiving the yellow converted light 33b is provided to use yellow light in visible light communication. Thus a higher transmission rate on the order of Mbps is achieved for space optical transmission.

Furthermore, visible light communication allows the transmission state between the light emitting device 21 of the transmitting section 10 and the light receiver 17 of the receiving section 15 to be verified at a glance. The complexity of verifying the receiving state at the receiving section 15 is significantly reduced.

A light receiving device such as a silicon-based light receiving element would be more sensitive to the yellow light than the blue light. Thus, it may be possible to receive the yellow light more sensitively than the blue light. However, even in the case of the silicon-based light receiving element, it may be sensitive to visible light of all the wavelengths from violet to red, near-ultraviolet light, and near-infrared light. Then these lights may act as noise to illuminating light intended for communication. As a result, for example, the light receiver may frequently suffer from receiving noise even indoors. With a filter 16 for using a specific wavelength, the frequency of suffering from receiving noise can be reduced.

According to this embodiment, the light emitting device 21 is simple and practical for providing white light illumination as a combination of blue and yellow excited light. Furthermore, the visible light communication oriented illumination device 1 including the light emitting device 21 selectively receives the yellow converted light 33b having a short persistence time, thereby achieving faster visible light communication.

### Second Embodiment

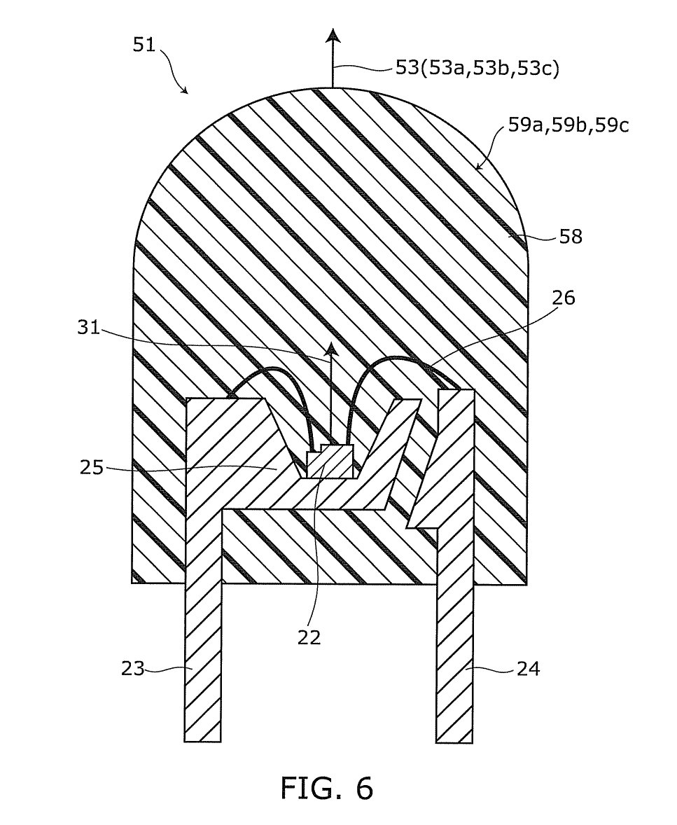

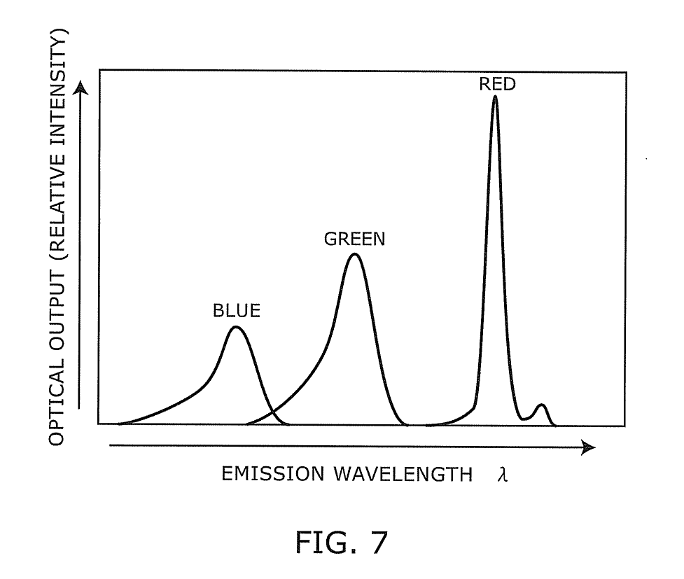

A light emitting device according to the second embodiment is described with reference to FIGS. 6 and 7. As shown in FIG. 6, the light emitting device 51 includes an LED chip 22 serving as a light emitting element which emits an excitation light 31, a phosphor 59a serving as a first wavelength-converting material which absorbs the excitation light 31 and emits a red converted light 53a as a first visible light, a phosphor 59b serving as a second wavelength-converting material which absorbs the excitation light 31 and emits a green converted light 53b as a second visible light, and a phosphor 59c serving as a third wavelength-converting material which absorbs the excitation light 31 and emits a blue converted light 53c as a third visible light, which has a shorter wavelength and shorter persistence time than the first and second visible light.

The phosphors 59a, 59b, 59c contain luminescent centers (activation centers) localized in the solid and are excited by a near-ultraviolet excitation light 31 having an intensity peak at 400 nm or less emitted from the LED chip 22. A red converted light 53a, a green converted light 53b, and a blue converted light 53c emitted from the phosphors 59a, 59b, 59c, respectively, are combined into a white converted light 53 available as an illuminating light. The converted lights 53a, 53b, 53c emitted by the phosphors 59a, 59b, 59c can be used for visible light communication, although the modulation rate is lower than that for the LED chip 22 because the converted lights 53a, 53b, 53c have some persistence.

The phosphor 59a is illustratively La₂O₂S:Eu(3+), which emits red. The phosphor 59b is illustratively BaMgAl₁₀O₁₇:Eu(2+−),Mn(2+), which emits green. The phosphor 59c is illustratively BaMgAl₁₀O₁₇:Eu(2+), which emits blue. The phosphors 59a, 59b, 59c have a persistence time of about 1 msec, about 10 msec, and 3 to 5 μsec, respectively. Phosphors activated with Eu tends to have a shorter persistence time for divalent than for trivalent Eu. Thus emission from phosphors activated with divalent Eu is used for visible light communication. Note that, while the phosphors 59a, 59b, 59c fluorescing red, green, and blue light are combined in this embodiment, any combination of three types of phosphors having other fluorescent colors can be used as long as they are combined into white light. The sealing resin 58 contains three types of phosphors 59a, 59b, 59c.

Some of the features of the above-described light emitting device 51 are summarized as follows. The LED chip 22 emits a near-ultraviolet excitation light 31. The near-ultraviolet excitation light 31 is absorbed by phosphors 59a, 59b, 59c. As shown in FIG. 7, the phosphor 59a emits a red converted light 53a having an intensity peak at 620 to 630 nm. The phosphor 59b emits a green converted light 53b having an intensity peak at 510 to 540 nm. The phosphor 59c emits a blue converted light 53c having an intensity peak at 440 to 460 nm. As a result of combination of the red converted light 53a, the green converted light 53b, and the blue converted light 53c, the light emitting device 51 emits a white converted light 53.

A visible light communication oriented illumination device (not shown) based on the light emitting device 51 is configured similarly to the visible light communication oriented illumination device 1 of the first embodiment except that the filter of the light receiver is configured to selectively transmit blue light. However, the persistence time of blue light in this embodiment is one or more orders of magnitude longer than the persistence time of yellow light in the first embodiment. Therefore the transmission rate is one or more orders of magnitude lower in this embodiment.

In the light emitting device 51, the near-ultraviolet light emitted from the LED chip 22 serves as an excitation light 31, and red, green, and blue converted light 53a, 53b, 53c are emitted as an illuminating light from the phosphors 59a, 59b, 59c excited by the excitation light 31. The white illumination of the converted light 53 obtained by combining these three colors has higher rendition than the white illumination in the first embodiment, and the color of an object can be made similar to that in natural light.

Moreover, the light emitting device 51 is based on phosphors 59a, 59b, 59c with different persistent times, among which the converted light from the blue phosphor 59c having the shortest persistence time is used in visible light communication. With regard to the transmission rate, although falling short of the visible light communication oriented illumination device 1 in the first embodiment, this embodiment can achieve a transmission rate of tens to hundreds of kbps for space optical transmission.

The light emitting device 51 and the visible light communication oriented illumination device based thereon according to this embodiment put emphasis on white illumination and, as compared with the visible light communication oriented illumination device 1 of the first embodiment, is more advantageous in application to visible light communication which does not need to transmit a large amount of data in a short period of time. For example, for home use, either the light emitting device 21 and the visible light communication oriented illumination device 1 based thereon according to the first embodiment or the light emitting device 51 and the visible light communication oriented illumination device based thereon according to this embodiment can be used on a room-by-room basis.

### Third Embodiment

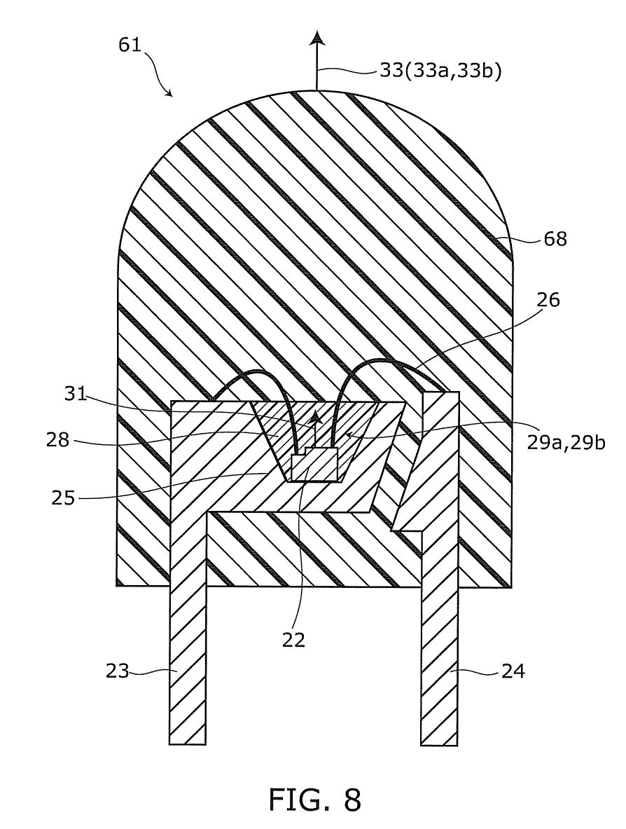

A light emitting device according to the third embodiment of the invention is described with reference to FIG. 8. As shown in FIG. 8, the light emitting device 61 is similar to the light emitting device 21 of the first embodiment. However, the light emitting device 61 is different in that the sealing resin 28, which contains a phosphor 29a absorbing the excitation light 31 and fluorescing a blue converted light 33a, and a phosphor 29b absorbing the excitation light 31 and fluorescing a yellow converted light 33b, is provided restrictively in the recess of the cup portion 25 so as to cover the LED chip 22. A transparent resin 68 is formed into a bullet shape so as to seal the sealing resin 28 including the LED chip 22, the cup portion 25, one end of the leads 23, 24, and the wires 26. The surface of the sealing resin 28 on the tip side is formed into a plane, a convex surface, or a concave surface.

The transparent resin 68 is an epoxy-based or silicone-based resin and substantially transparent to visible light. By confining the phosphors 29a, 29b to a small portion in the transparent resin 68, the emitting portion can be downsized to enhance brightness.

Light from the light emitting device 61 can be focused as compared with the light emitting device 21 of the first embodiment, and white light can be transmitted so as to be focused on the light receiver. As a result, the distance between the light emitting device 61 and the light receiver can be increased.

### Fourth Embodiment

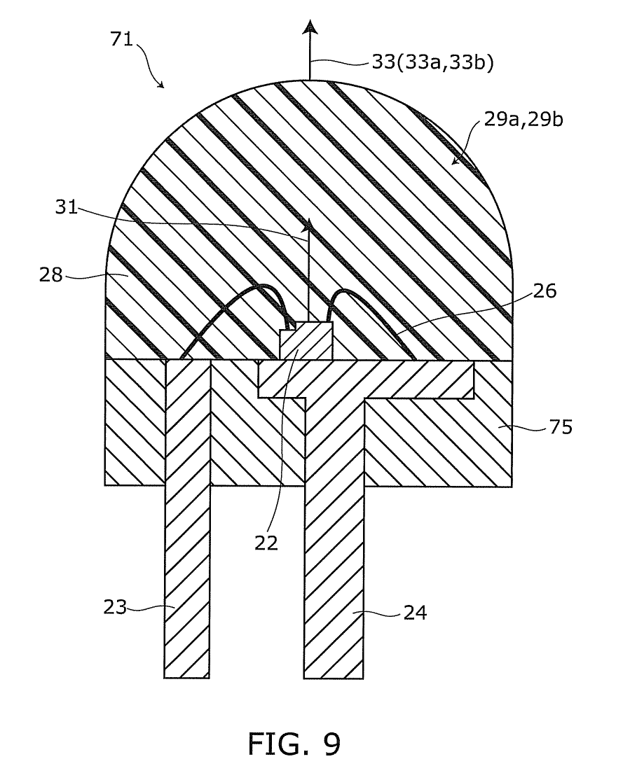

A light emitting device according to the fourth embodiment is described with reference to FIG. 9. As shown in FIG. 9, the light emitting device 71 is similar to the light emitting device 21 of the first embodiment. However, in the light emitting device 71, the LED chip 22 is fixed to a lead 24 exposed on the surface of a stem 75 made of ceramic or other insulating material. The sealing resin 28, which contains a phosphor 29a absorbing the excitation light 31 and fluorescing a blue converted light 33a, and a phosphor 29b absorbing the excitation light 31 and fluorescing a yellow converted light 33b, is formed into a bullet shape so as to seal the LED chip 22, one end of the leads 23, 24, and the wires 26 on the top face of the stem 75 where the leads 23, 24 are exposed. The stem 75 can be made of an insulating resin.

The stem 75 is shaped as a cylinder. The leads 23, 24 are exposed on the top face of the stem 75 so as to have generally coplanar end faces to which the LED chip 22 is fixed and the wires 26 are connected. The leads 23, 24 extend to the opposite side of the exposed surface. The stem 75 is relatively small because it needs only to allow the LED chip 22 to be fixed and the wires 26 to be connected. Furthermore, in the light emitting device 71 based on the stem 75, the fixing surface for the LED chip 22 and the connecting surface for the wires 26 are generally coplanar. Therefore the light emitting device 71 can be assembled relatively easily, and the manufacturing cost can be reduced.

The light emitting device 71 is small relative to the light emitting device 21 of the first embodiment, and hence the number of light emitting devices 71 per packaging area can be increased. As a result, the amount of light per area as an illuminating device can be improved. This is suitable to the purpose of brighter illumination or more distant transmission.

### Fifth Embodiment

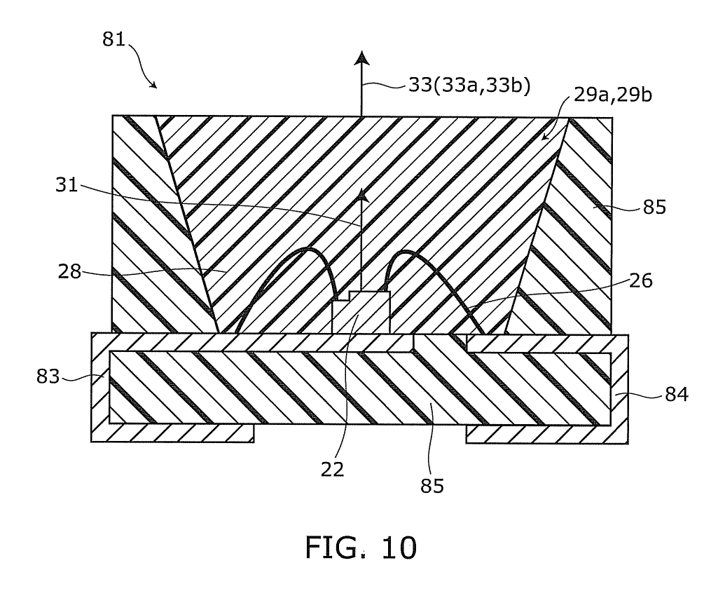

A light emitting device according to the fifth embodiment of the invention is described with reference to FIG. 10.As shown in FIG. 10, the light emitting device 81 includes a resin enclosure 85 having a recess which opens toward the tip and has an inner wall side face and an inner wall bottom face, a pair of leads 83, 84 part of which is embedded in the resin enclosure 85, an LED chip 22 fixed onto one lead 83 exposed on the bottom face of the recess of the resin enclosure 85, wires 26 electrically connecting the LED chip 22 to the leads 83, 84 exposed on the recess bottom face, and a sealing resin 28 containing phosphors 29a, 29b, filling the recess of the resin enclosure 85, and sealing the LED chip 22 and the wires 26.

The leads 83, 84 exposed from the resin enclosure 85 are folded along the contour of the resin enclosure 85 so as to form a plane with respect to the mounting surface. While the surface of the sealing resin 28 on the tip side is formed into a plane, it can be formed into a convex surface or a concave surface. The inner wall side face of the recess of the resin enclosure 85 is formed into a smooth surface, which reflects and emits the excitation light 31 of the LED chip 22 and the converted light 33 toward the tip.

The light emitting device 81 is small in height relative to the light emitting device 21 of the first embodiment, and hence can be mounted on a planar mounting surface. As a result, the light emitting device 81 can be mounted on a printed wiring board having planar interconnects. Thus packaging can be conducted more easily, and the spatial packaging efficiency can be improved. The invention is not limited to the embodiments described above, but can be practiced in various modifications without departing from the spirit and scope of the invention.

For example, in the above embodiments, as a converted light having a short persistence characteristic, yellow light is selected when two types of phosphors are used, and blue light is selected when three types of phosphors are used. However, the converted light selected in the embodiments does not always have a short persistence characteristic depending on the combination of phosphors. In this case, a converted light having the shortest persistence time among the two or three types of phosphors can be selected for use in transmission.

In the embodiments, an LED chip having an emission intensity peak at 360 to 380 nm is illustratively used. However, it is possible to use, for example, an (Al,In,Ga)N-based or BN-based LED chip having an emission intensity peak at 350 nm or less. When an excitation light of 300 nm or less is used, phosphors having a shorter persistence time (e.g., phosphors activated with Ce) can be used to achieve efficient emission. Thus the transmission rate of the visible light communication oriented illumination device can be improved.

In the embodiments, an LED chip based on an insulative substrate is illustratively used. However, an LED chip based on a conductive substrate can also be used. In this case, electrical connection can be made through the conductive substrate, and the number of wires can be reduced to one. Thus the light extraction efficiency can be improved. An LD (Laser Diode) can also be used as the light emitting element.

In the third to fifth embodiment, two types of phosphors fluorescing blue and yellow are illustratively used. However, the three types of phosphors fluorescing red, green, and blue described in the second embodiment can be applied to the third to fifth embodiment.

Phosphors are not limited to those used in the embodiments. Other phosphors can be combined to produce white light. In the same way as conventional fluorescent lamps are categorized as neutral white, daylight white, and warm white according to color temperature, the white light in the above embodiments can be varied with color temperature.

1. A visible fight communication oriented illumination device comprising:
a transmitting section including:
a light emitting element which emits an excitation light;
a first wavelength-converting material which absorbs the excitation light and emits a first light; and
a second wavelength-converting material which absorbs the excitation light and emits a second light which is different in wavelength and has a shorter 1/10 persistence time than the first light,
the transmission section being configured to emit an illuminating light including the first and second lights; and
a receiving section including:
a receiver which receives the second light and transforms the second light into an electrical signal; and
a demodulator which receives the electrical signal outputted from the receiving section and outputs a signal corresponding to an information transmitted from the transmitting section.

2. The visible light communication oriented illumination device of claim 1, wherein the transmitting section further includes a light emission controller which generates a modulating electrical signal for transmitting the information, and the light emitting element emits the excitation light whose intensity is modulated in response to the modulating electrical signal.

3. The visible light communication oriented illumination device of claim 1, wherein the receiving section includes a filter, a transmittance of the filter for the second light is higher than a transmittance of the filter for the first light.

4. The visible light communication oriented illumination device of claim 1, wherein the first light is a blue light, and the second light is a yellow light.

5. The visible light communication oriented illumination device of claim 1, wherein the second wavelength-converting material is a YAG activated with Ce.

6. The visible light communication oriented illumination device of claim 1, wherein the light emitting element has an intensity peak at a wavelength of 400 nm or less.

7. The visible light communication oriented illumination device of claim 1, wherein the transmission section further includes a third wavelength-converting material which absorbs the excitation light and emits a third light which is different in wavelength from the first and second lights, and the illuminating light further includes the third light.

8. The visible light communication oriented illumination device of claim 7, wherein the first light is a red light, the second light is a blue light, and the third light is a green light.

9. The visible light communication oriented illumination device of claim 7, wherein the second wavelength-converting material is phosphors activated with divalent Eu.

10. The visible light communication oriented illumination device of claim 7, wherein the receiving section further includes a filter, a transmittance of the filter for the second light is higher than a transmittance of the filter for the first light and a transmittance of the filter for the third light.

11. A visible light communication oriented illumination device comprising:
a light emission controller which generates a modulating electrical signal for transmitting information;
a light emitting device including:
a light emitting element which emits an intensity-modulated excitation light in response to the modulating electrical signal;
a first wavelength-converting material which absorbs the excitation light and emits a first visible light; and
a second wavelength-converting material which absorbs the excitation light and emits a second visible light which is different in wavelength and has a shorter 1/10 persistence time than the first visible light; and
a receiving section which receives the second visible light.

12. The visible light communication oriented illumination device of claim 11, wherein the receiving section includes a light receiving element which is more sensitive to the second visible light than the first visible light.

13. The visible light communication oriented illumination device of claim 11, wherein the receiving section includes a filter, a transmittance of the filter for the second visible light is higher than a transmittance of the filter for the first visible light.

14. The visible light communication oriented illumination device of claim 11, wherein the first visible light is a blue light, and the second visible light is a yellow light.

15. The visible light communication oriented illumination device of claim 11, wherein the second wavelength-converting material is a YAG activated with Ce.

16. The visible light communication oriented illumination device of claim 11, wherein the light emitting element has an intensity peak at a wavelength of 400 nm or less.

17. The visible light communication oriented illumination device of claim 11, wherein the transmission section further includes a third wavelength-converting material which absorbs the excitation light and emits a third visible light which is different in wavelength from the first and second visible light, and the second visible light has a shorter 1/10 persistence time than the third visible light.

18. The visible light communication oriented illumination device of claim 17, wherein the first visible light is a red light, the second visible light is a blue light, and the third visible light is a green light.

19. The visible light communication oriented illumination device of claim 17, wherein the second wavelength-converting material is phosphors activated with divalent Eu.
